(19) United States
(12) Patent Application Publication
(10) Pub. No.: US 2020/0401788 A1
(43) Pub. Date: Dec. 24, 2020

(54) DISTINGUISHING AN IMAGE OF A THREE-DIMENSIONAL OBJECT FROM AN IMAGE OF A TWO-DIMENSIONAL RENDERING OF AN OBJECT

(71) Applicant: International Business Machines Corporation, Armonk, NY (US)

(72) Inventors: David Okun, Austin, TX (US); Justin Mccoy, Austin, TX (US)

(73) Assignee: International Business Machines Corporation, Armonk, NY (US)

(21) Appl. No.: 16/444,574

(22) Filed: Jun. 18, 2019

(51) Int. Cl. G06K 9/00; H04N 13/271; G06K 9/62

(52) U.S. Cl. CPC G06K 9/00208; G06K 9/627; H04N 13/271

(57) ABSTRACT

An image classification model is configured to classify a subject viewed via a multi-camera apparatus. A depth classification model is configured to distinguish between a depth characteristic of a 3D subject and a depth characteristic of a realistic 2D rendering of a 3D subject, using depth information provided by viewing a subject via a multi-camera apparatus. A 2D rendering of a 3D subject is presented as an input to a multi-camera apparatus, the multi-camera apparatus operating the image classification model and the depth classification model. Using the multi-camera apparatus, a first depth information corresponding to the input is collected. The first depth information is provided to the depth classification model. Responsive to the depth classification model classifying the input as a 2D rendering, the 2D rendering is rejected as being the 3D subject.

### TECHNICAL FIELD

The present invention relates generally to a method, system, and computer program product for image classification. More particularly, the present invention relates to a method, system, and computer program product for distinguishing an image of a three-dimensional object from an image of a two-dimensional rendering of an object.

### BACKGROUND

Camera apparatuses that can generate depth information for elements within a scene, as well as a conventional two-dimensional rendering of scene, have become increasingly available. Depth information is a distance from a camera to a portion of an image. Depth information is determined either in absolute terms (e.g. a particular number of meters from the camera apparatus to a portion of the image) or relative to another portion of the image.

One type of camera apparatus collects depth information using two similar cameras in close proximity to each other on the apparatus. Both cameras produce images of approximately the same scene at approximately the same time. Because the two cameras are a small distance apart, similar features found in both resulting images show a parallax shift. In other words, when comparing the two images, an object that is closer to the cameras shifts by a greater distance than an object that is further from the cameras. This difference, or disparity, is usable to infer the relative distances from the camera apparatus to objects in either of the images. Using relative distances, although a distance measurement between the apparatus and an individual point in the image is typically not sufficiently accurate for a reliable distance measurement, the variation between distances to points in the image is consistent enough to use for depth-based image processing effects. In addition, the cameras need not be identical. For example, one camera may have a different focal length or aperture than another, or the two cameras may have different ranges of adjustability for focal length, aperture, and other adjustable settings.

Another type of camera apparatus uses a camera to capture a conventional image of a scene. This type of apparatus also projects an infrared light pattern in front of the apparatus and images that pattern with an infrared camera. By observing how the pattern is distorted by objects in the scene, the apparatus calculates the distance from the camera to each point in the image.

Both types of camera apparatuses, as well as others not specifically described, are referred to herein as multi-camera apparatuses. When configured as a still camera, a multi-camera apparatus typically produces one image of a scene, along with depth information for points within the produced image. When configured as a video camera, a multi-camera apparatus typically produces video of a scene, along with depth information for points within the produced video.

A multi-camera apparatus can also include more than two cameras, or more than two types of cameras. In addition, a multi-camera apparatus is not limited to cameras that capture images using the visible light spectrum, but also includes cameras that capture images using other electromagnetic frequencies, including as non-limiting examples radio waves, microwaves, x-rays, and infrared and ultraviolet light. The wavelength (or conversely, frequency) of the electromagnetic radiation to be captured and the distance from the apparatus to a scene to be captured determines a suitable distance for the cameras within a multi-camera apparatus. For example, one smartphone device that includes a visible-light multi-camera apparatus has a camera separation of approximately one centimeter, while imaging a distant galaxy using radio waves may require a camera separation of thousands of kilometers.

The depth information obtained using a multi-camera apparatus is usable to perform many adjustments to a captured scene, without requiring the scene to be recaptured. For example, depth information can be used to separate foreground objects from the background of the scene. Depth information can also be used to vary the depth of field of the scene, blurring or sharpening various objects in the scene.

### SUMMARY

The illustrative embodiments provide a method, system, and computer program product. An embodiment includes a method that configures an image classification model to classify a subject viewed via a multi-camera apparatus. An embodiment configures a depth classification model to distinguish between a depth characteristic of a 3D subject and a depth characteristic of a realistic 2D rendering of a 3D subject, using depth information provided by viewing a subject via a multi-camera apparatus. An embodiment presents a 2D rendering of a 3D subject as an input to a multi-camera apparatus, the multi-camera apparatus operating the image classification model and the depth classification model. An embodiment collects, using the multi-camera apparatus, a first depth information corresponding to the input. An embodiment provides the first depth information to the depth classification model. An embodiment rejects, responsive to the depth classification model classifying the input as a 2D rendering, the 2D rendering as being the 3D subject

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for distinguishing an image of a three-dimensional object from an image of a two-dimensional rendering of an object in accordance with an illustrative embodiment;

FIG. 4 depicts another block diagram of an example configuration for distinguishing an image of a three-dimensional object from an image of a two-dimensional rendering of an object in accordance with an illustrative embodiment;

FIG. 5 depicts an example of depth image creation, for use in distinguishing an image of a three-dimensional object from an image of a two-dimensional rendering of an object in accordance with an illustrative embodiment;

FIG. 6 depicts an example of distinguishing an image of a three-dimensional object from an image of a two-dimensional rendering of an object in accordance with an illustrative embodiment;

FIG. 7 depicts another example of distinguishing an image of a three-dimensional object from an image of a two-dimensional rendering of an object in accordance with an illustrative embodiment; and

FIG. 8 depicts a flowchart of an example process for distinguishing an image of a three-dimensional object from an image of a two-dimensional rendering of an object in accordance with an illustrative embodiment.

### DETAILED DESCRIPTION

The illustrative embodiments recognize that there is a need to distinguish an image of a three-dimensional (3D) object from an image of a two-dimensional (2D) rendering of a 3D object. For example, a person might gain access to a secured location such as a building by presenting an identification card to a camera-based security system, presenting one's face to a camera-based security system for facial recognition, or presenting one's retina to a camera-based security system for retinal scanning. Without the ability to distinguish an image of a three-dimensional (3D) object from an image of a two-dimensional (2D) rendering of a 3D object, an unauthorized person might gain access to the location by presenting a photograph of an authorized person's identification card, face, or retina.

Distinguishing an image of a 3D object from an image of a 2D rendering of a 3D object is also important in detecting that a video or still image has been altered. For example, an image of a scene should not contain a portion in which an object's depth is very different from that of other objects that appear to be nearby. As well, a video clip of a scene should not include an object having a depth that varies unrealistically quickly from one frame to the next.

In addition, many presently-available handheld devices, such as smartphones, already include a multi-camera apparatus and suitable processor. The illustrative embodiments recognize that using presently-available hardware eliminates a need for a custom-built apparatus. However, presently-available hardware simply collects image and depth information, and is not capable of distinguishing an image of a three-dimensional (3D) object from an image of a two-dimensional (2D) rendering of a 3D object.

The illustrative embodiments recognize that the presently available tools or solutions do not address these needs or provide adequate solutions for these needs. The illustrative embodiments used to describe the invention generally address and solve the above-described problems and other problems related to distinguishing an image of a three-dimensional object from an image of a two-dimensional rendering of an object.

An embodiment can be implemented as a software application. The application implementing an embodiment can be configured as a modification of an existing image analysis system, as a separate application that operates in conjunction with an existing image analysis system, a standalone application, or some combination thereof.

Particularly, some illustrative embodiments provide a method that configures two different models, then uses the configured models to distinguish an image of a three-dimensional object from an image of a two-dimensional rendering of an object.

An embodiment configures an image classification model to classify a subject viewed via a multi-camera apparatus. The subject may be viewed in real time or captured and viewed at a later time. In one embodiment, the image classification model is a neural network-based model, for example a convolutional neural network (CNN). During the configuration process, an embodiment uses labelled images of various subjects to train the neural network-based model to classify a subject of an image according to the training. For example, an image classification model that is intended to classify an image subject as either a human face or something other than a human face could be trained using a set of images labelled as including a human face and another set of images labelled as not including a human face. As another example, an image classification model that is intended to classify an image subject into one of a set of known household objects (e.g. chairs, books, tables, televisions, remote controls, sofas, etc.) could be trained using a set of images labelled as including a particular known household object and another set of images labelled as not including a particular known household object.

For ease in processing, an embodiment converts depth information produced by a multi-camera apparatus into a depth map. A depth map indicates distance from the camera to pictorial form. In particular, a greyscale value of a pixel in a depth map represents a distance from the camera for a corresponding pixel in an image of the scene. Thus, a portion of an image that includes an object close to the multi-camera apparatus has a corresponding portion of a depth map with a greyscale value indicating a short distance to the object (for example, 0.1 on a 0-1 scale, where 0 represents white and 1 represents black). Another portion of image that includes an object farther away from the multi-camera apparatus has a corresponding portion of a depth map with a greyscale value indicating a farther distance to the object (for example, 0.8 on the same 0-1 scale)s. Converting depth information produced by a multi-camera apparatus into a depth map allows the treatment of depth information using existing image processing techniques.

An embodiment configures a depth classification model to distinguish between a 3D subject and a realistic 2D rendering of a 3D subject, using a depth map created from the depth information provided by viewing a subject via a multi-camera apparatus. The subject may be viewed in real time or captured and viewed at a later time. In one embodiment, the depth classification model is a neural network-based model, for example a convolutional neural network (CNN). During the configuration process, an embodiment uses labelled depth maps corresponding to images of various subjects to train the neural network-based model to distinguish between a 3D subject and a realistic 2D rendering of a 3D subject according to the training. For example, a depth classification model could be trained using a set of depth maps labelled as corresponding to a 3D subject and another set of images labelled as not corresponding to a 3D subject.

Other image classification models and depth classification models, both neural network-based and not utilizing a neural network, are also possible and contemplated within the scope of the illustrative embodiments. Other configuration methods for each model, using unsupervised learning or using a set of learned or static rules, are also possible and contemplated within the scope of the illustrative embodiments. In addition, one embodiment can implement model configuration as a one-time process, and another embodiment can implement model configuration on an ongoing basis, allowing additional model refinement as an embodiment is used to classify an object in a scene.

Once an embodiment has configured an image classification model and a depth classification model, the embodiment operates the models to classify objects in scenes viewed using the multi-camera apparatus. In particular, from a scene viewed via the multi-camera apparatus, an embodiment uses the image classification model to classify a subject in the scene. From the same scene, an embodiment uses the depth information provided by the multi-camera apparatus to construct a depth map corresponding to the scene. The embodiment uses the depth classification model to classify the depth map as either a 3D subject or a realistic 2D rendering of a 3D subject. If the embodiment classifies the depth map as a 3D subject, the embodiment accepts the subject of the scene as a physical subject. If the embodiment classifies the depth map as a 2D rendering of a 3D subject, the embodiment rejects the subject of the scene as not being a physical subject.

An embodiment can configure the models using one system, then execute the configured models using a different system, such as a system with less processing power than then configuration system. In this manner, classifying a subject in a scene can be accomplished without relying on a network connection to a system other than the host of the multi-camera apparatus. In addition, a subject of a scene can be classified quickly enough for use in real-time on video as well as still images.

The manner of distinguishing an image of a three-dimensional object from an image of a two-dimensional rendering of an object described herein is unavailable in the presently available methods in the technological field of endeavor pertaining to image analysis. A method of an embodiment described herein, when implemented to execute on a device or data processing system, comprises substantial advancement of the functionality of that device or data processing system in configuring an image classification model and a depth classification model, then uses the configured models to classify a subject in a scene viewed using a multi-camera apparatus as either a 3D subject or a 2D rendering of a 3D subject.

The illustrative embodiments are described with respect to certain types of cameras, camera sensors, multi-camera apparatuses, depth information, scenes, subjects, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

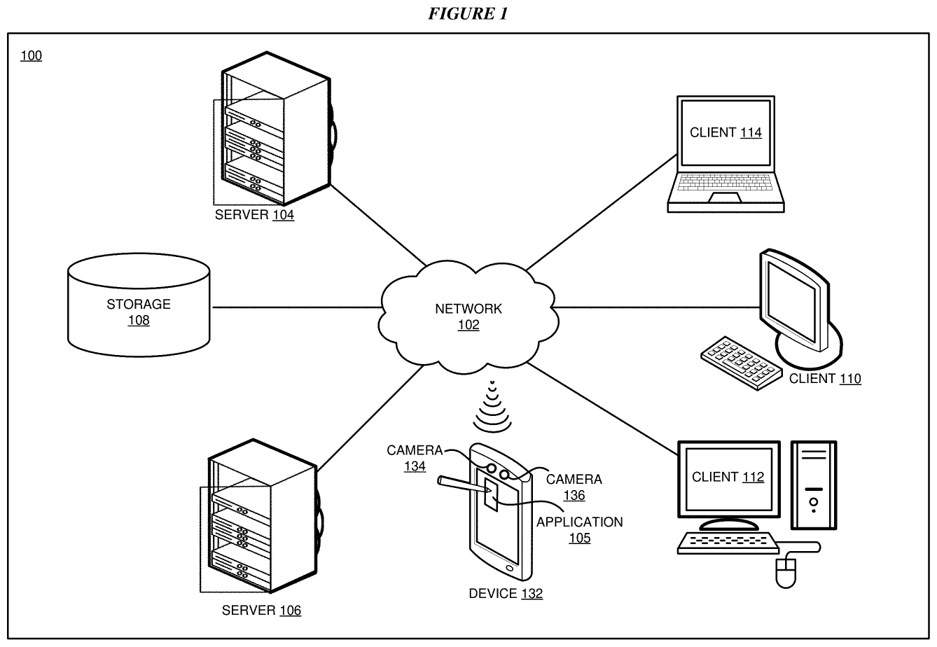

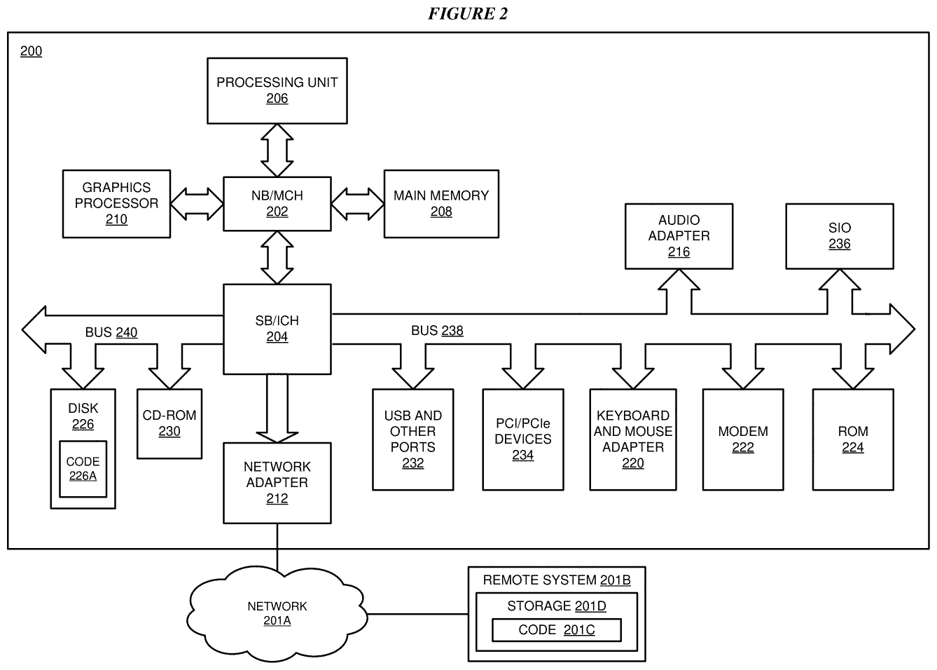

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Device 132 includes camera 134 and camera 136. Camera 134 and camera 136, taken together, are an example of a multi-camera apparatus as described herein. Camera 134 and camera 136 can also be installed in any of data processing systems 104, 106, 110, 112, and 114.

Application 105 implements an embodiment described herein. Application 105 can use camera 134 and camera 136 to view a scene, obtain depth information for the scene, and distinguish an image of a three-dimensional object from an image of a two-dimensional rendering of an object. Application 105 can also execute in any of data processing systems 104, 106, 110, 112, and 114, and need not execute in the same system as camera 134 and camera 136.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

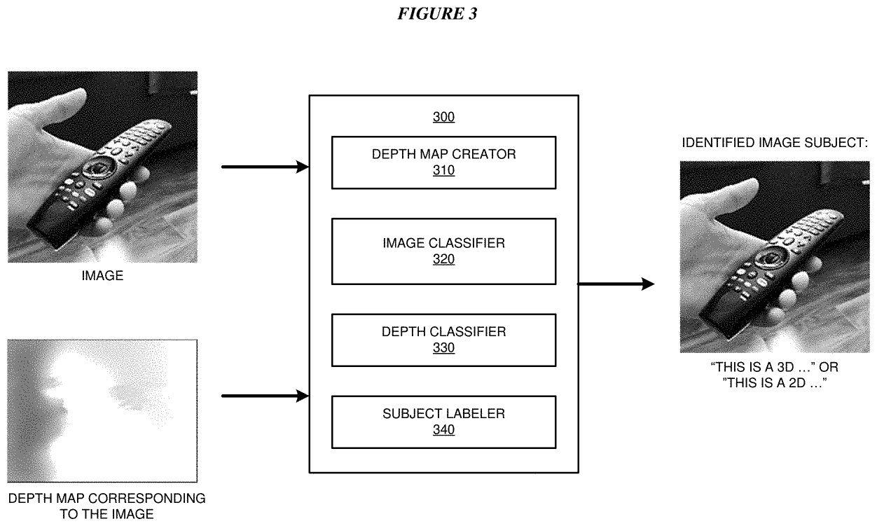

With reference to FIG. 3, this figure depicts a block diagram of an example configuration for distinguishing an image of a three-dimensional object from an image of a two-dimensional rendering of an object in accordance with an illustrative embodiment. Application 300 is an example of application 105 in FIG. 1 and executes in any of servers 104 and 106, clients 110, 112, and 114, and device 132 in FIG. 1.

Depth map creator 310 converts depth information produced by a multi-camera apparatus into a depth map. In the depth map, a greyscale value of a pixel represents a distance from the camera for a corresponding pixel in an image of the scene.

Application 300 configures image classifier 320, which includes an image classification model, to classify a subject viewed via a multi-camera apparatus. The subject may be viewed in real time or captured and viewed at a later time. In one implementation of application 300, image classifier 320 uses a CNN. During the configuration process, application 300 uses labelled images of various subjects to train the CNN to classify a subject of an image according to the training.

Application 300 configures depth classifier 330, including a depth classification model, to distinguish between a 3D subject and a realistic 2D rendering of a 3D subject, using a depth map created by module 310. The subject may be viewed in real time or captured and viewed at a later time. In one implementation of application 300, depth classifier 330 uses a CNN. During the configuration process, application 300 uses labelled depth maps corresponding to images of various subjects to train the neural network-based model to distinguish between a 3D subject and a realistic 2D rendering of a 3D subject according to the training. For example, a depth classification model could be trained using a set of depth maps labelled as corresponding to a 3D subject and another set of images labelled as not corresponding to a 3D subject.

Once application 300 has configured an image classification model and a depth classification model, image classifier 320 and depth classifier 330 classify objects in scenes viewed using the multi-camera apparatus. In particular, from a scene viewed via the multi-camera apparatus, image classifier 320 uses the image classification model to classify a subject in the scene. From the same scene, depth map creator 310 uses the depth information provided by the multi-camera apparatus to construct a depth map corresponding to the scene. Depth classifier 330 uses the depth classification model to classify the depth map as either a 3D subject or a realistic 2D rendering of a 3D subject. Subject labeler 340 labels a subject of the scene according to image classifier 320's classification. As well, if depth classifier 330 classifies the depth map as a 3D subject, subject labeler 340 further labels the subject of the scene as a physical subject. If depth classifier 330 classifies the depth map as a 2D rendering of a 3D subject, subject labeler 340 further labels the subject of the scene as not being a physical subject.

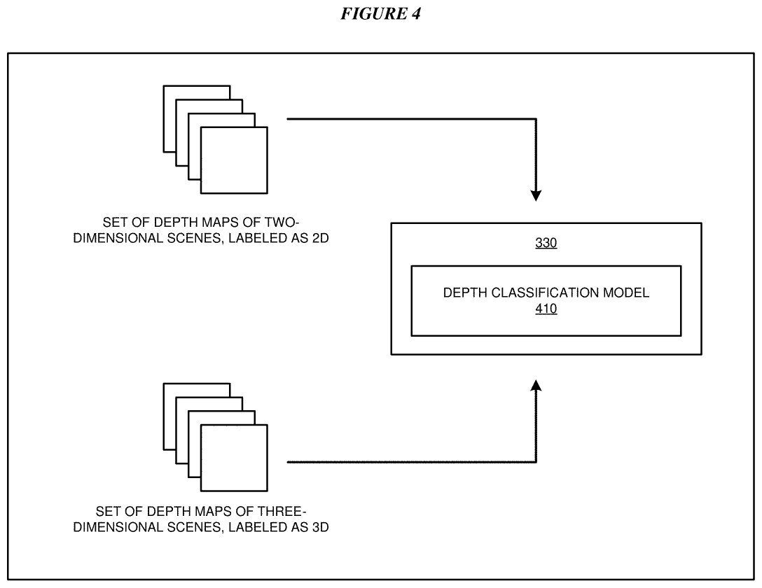

With reference to FIG. 4, this figure depicts another block diagram of an example configuration for distinguishing an image of a three-dimensional object from an image of a two-dimensional rendering of an object in accordance with an illustrative embodiment. FIG. 4 provides more detail of the configuration of depth classifier 330 in FIG. 3.

Depth classifier 330 includes depth classification model 410. During the configuration process, application 300 uses a set of depth maps labelled as corresponding to a 3D subject and another set of images labelled as not corresponding to a 3D subject to train depth classification model 410 to distinguish between a 3D subject and a realistic 2D rendering of a 3D subject according to the training.

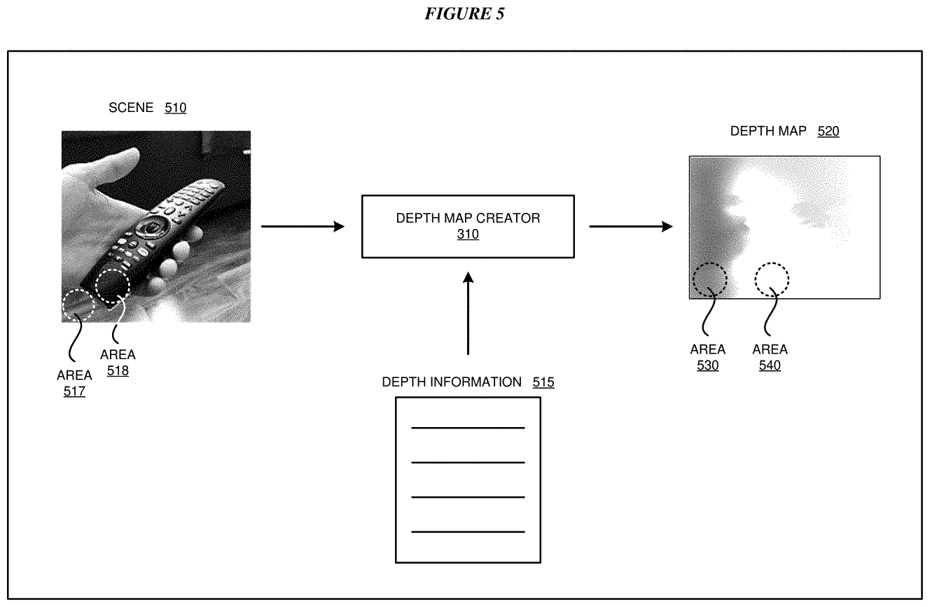

With reference to FIG. 5, this figure depicts an example of depth image creation, for use in distinguishing an image of a three-dimensional object from an image of a two-dimensional rendering of an object in accordance with an illustrative embodiment. The example can be executed using application 300 in FIG. 3. Depth map creator 310 is the same as depth map creator 310 in FIG. 3.

In particular, FIG. 5 depicts an example of converting depth information produced by a multi-camera apparatus into a depth map. As depicted, a multi-camera apparatus has produced scene 510 and corresponding depth information 515. Depth map creator 310 uses scene 510 and corresponding depth information 515 to produce depth map 520. In depth map 520, a greyscale value of a pixel represents a distance from the camera for a corresponding pixel in an image of the scene. Thus, area 518, a portion of scene 510 that includes an object close to the multi-camera apparatus (here, part of the remote control) corresponds to area 540, a corresponding portion of depth map 520 with a greyscale value indicating a short distance to the object (for example, 0.1 on a 0-1 scale, where 0 represents white and 1 represents black). Area 517, a portion of scene 510 that includes an object farther from the multi-camera apparatus than area 518 (here, part of the background of the scene) corresponds to area 530, a corresponding portion of depth map 520 with a greyscale value indicating a farther distance to the object (for example, 0.8 on the same 0-1 scale)s.

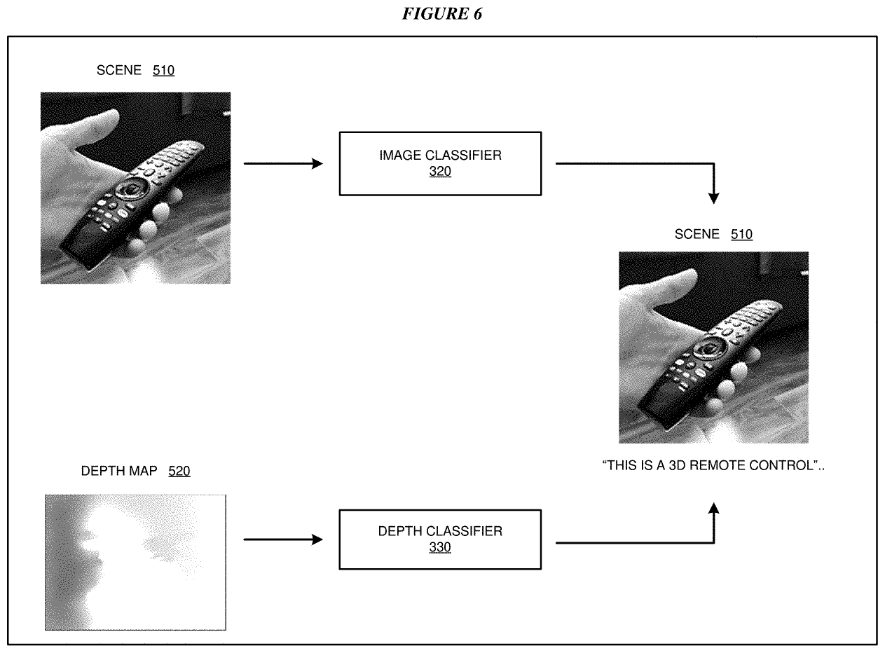

With reference to FIG. 6, this figure depicts an example of distinguishing an image of a three-dimensional object from an image of a two-dimensional rendering of an object in accordance with an illustrative embodiment. The example can be executed using application 300 in FIG. 3. Image classifier 320 and depth classifier 330 are the same as image classifier 320 and depth classifier 330 in FIG. 3. Scene 510 and depth map 520 are the same as scene 510 and depth map 520 in FIG. 5.

As depicted, scene 510 depicts a scene including a hand holding a remote control. Image classifier 320 uses a configured image classification model to classify a subject in scene 510. Here, image classifier 320 has classified a subject in scene 510 as a remote control. From depth map 520 corresponding to scene 510, depth classifier 330 uses a configured depth classification model to classify depth map 520 as either a 3D subject or a realistic 2D rendering of a 3D subject. Here, depth classifier 330 has classified depth map 520 as a 3D subject.

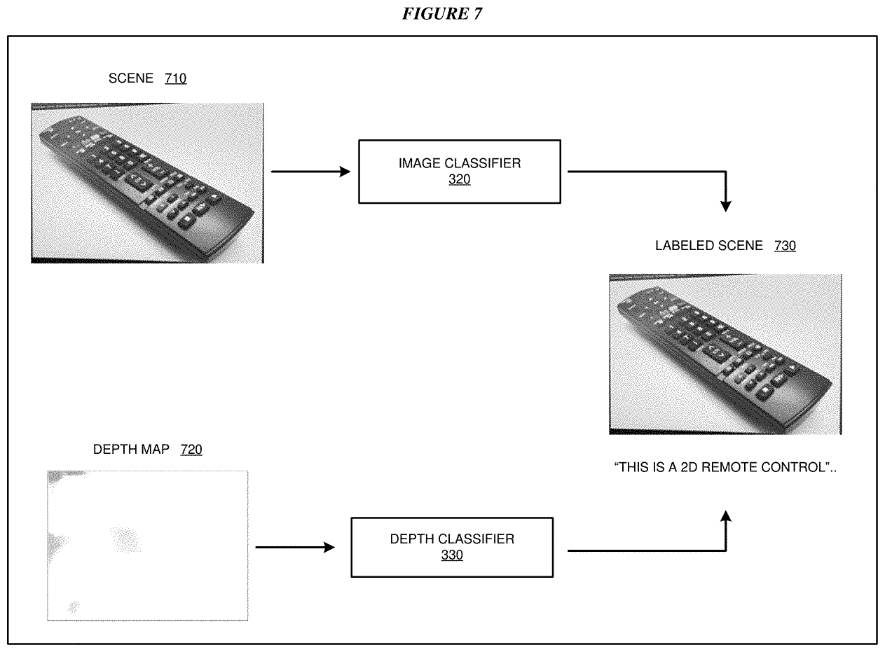

With reference to FIG. 7, this figure depicts another example of distinguishing an image of a three-dimensional object from an image of a two-dimensional rendering of an object in accordance with an illustrative embodiment. The example can be executed using application 300 in FIG. 3. Image classifier 320 and depth classifier 330 are the same as image classifier 320 and depth classifier 330 in FIG. 3.

As depicted, scene 710 depicts scene including a 2D rendering of a remote control. Image classifier 320 uses a configured image classification model to classify a subject in scene 710. Here, image classifier 320 has classified a subject in scene 710 as a remote control. From depth map 720 corresponding to scene 710, depth classifier 330 uses a configured depth classification model to classify depth map 720 as either a 3D subject or a realistic 2D rendering of a 3D subject. Here, depth classifier 330 has classified depth map 720 as a 2D subject.

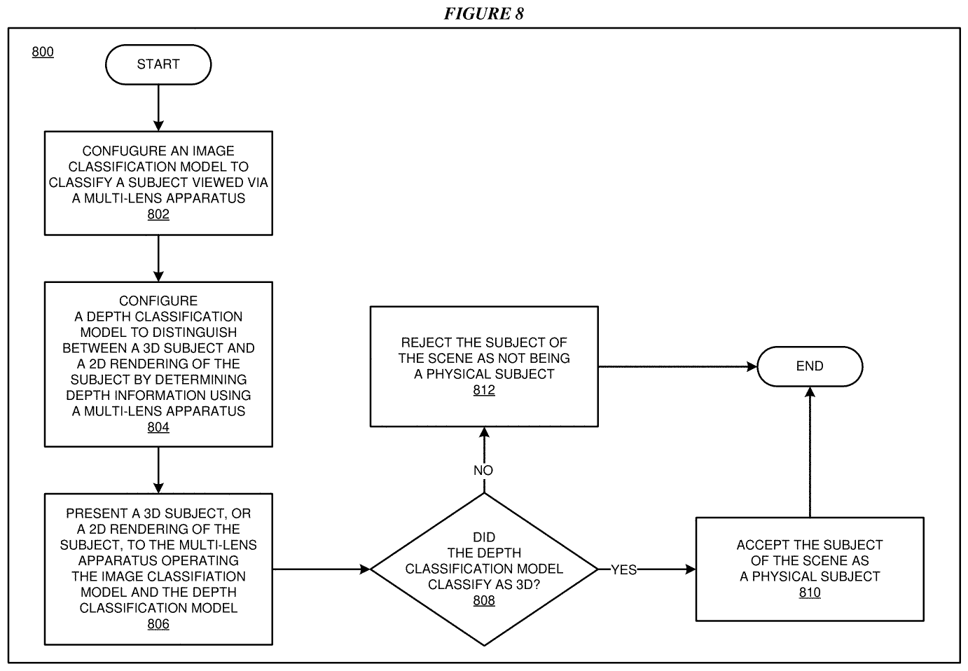

With reference to FIG. 8, this figure depicts a flowchart of an example process for distinguishing an image of a three-dimensional object from an image of a two-dimensional rendering of an object in accordance with an illustrative embodiment. Process 800 can be implemented in application 300 in FIG. 3.

In block 802, the application configures an image classification model to classify a subject viewed via a multi-lens apparatus. In block 804, the application configures a depth classification model to distinguish between a 3D subject and a 2D rendering of the subject by determining depth information using a multi-lens apparatus. In block 806, the application presents a 3D subject, or a 2D rendering of the subject, to the multi-lens apparatus operating the image classification model and the depth classification model. In block 808, the application checks whether the depth classification model classified the subject as 3D or not. If yes (“YES” path of block 808), in block 810, the application accepts the subject of the scene as a physical subject. Otherwise (“NO” path of block 808), in block 812, the application rejects the subject of the scene as not being a physical subject. Then the application ends.

Thus, a computer implemented method, system or apparatus, and computer program product are provided in the illustrative embodiments for distinguishing an image of a three-dimensional object from an image of a two-dimensional rendering of an object and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
presenting a 2D rendering of a 3D subject as an input to a multi-camera apparatus, the multi-camera apparatus operating an image classification model configured to classify a subject viewed via the multi-camera apparatus, and the multi-camera apparatus operating a depth classification model configured to distinguish between a depth characteristic of a 3D subject and a depth characteristic of a realistic 2D rendering of a 3D subject, using depth information provided by viewing a subject via the multi-camera apparatus;
collecting, using the multi-camera apparatus, a first depth information corresponding to the input;
providing the first depth information to the depth classification model; and
rejecting, responsive to the depth classification model classifying the input as a 2D rendering, the 2D rendering as being the 3D subject.

2. The computer-implemented method of claim 1, further comprising:
presenting a 3D subject as an input to the multi-camera apparatus;
collecting, using the multi-camera apparatus, a second depth information corresponding to the input;
providing the second depth information to the depth classification model; and
accepting, responsive to the depth classification model classifying the input as a 3D subject, the 3D subject as being the 3D subject.

3. The computer-implemented method of claim 2, further comprising:
generating, from a scene presented as an input to the multi-camera apparatus, a depth map corresponding to the input, a greyscale value of a pixel in the depth map corresponding to a distance from the multi-camera apparatus to a portion of the scene.

4. The computer-implemented method of claim 1, wherein configuring a depth classification model to distinguish between a 3D subject and a realistic 2D rendering of a 3D subject comprises training the depth classification model using a first set of depth information and a second set of depth information, the first set of depth information provided by viewing a set of 3D subjects via a multi-camera apparatus, the second set of depth information provided by viewing a set of realistic 2D renderings of the set of 3D subjects via a multi-camera apparatus.

5. The computer-implemented method of claim 1, wherein the depth classification model comprises a convolutional neural network model.

6. The computer-implemented method of claim 1, wherein the image classification model comprises a convolutional neural network model configured to classify a subject using a set of image classification training data, a training data in the set of image classification training data comprising an image and a classification corresponding to the image.

7. A computer usable program product comprising one or more computer-readable storage devices, and program instructions stored on at least one of the one or more storage devices, the stored program instructions comprising:
program instructions to present a 2D rendering of a 3D subject as an input to a multi-camera apparatus, the multi-camera apparatus operating an image classification model configured to classify a subject viewed via the multi-camera apparatus, and the multi-camera apparatus operating a depth classification model configured to distinguish between a depth characteristic of a 3D subject and a depth characteristic of a realistic 2D rendering of a 3D subject, using depth information provided by viewing a subject via the multi-camera apparatus;
program instructions to collect, using the multi-camera apparatus, a first depth information corresponding to the input;
program instructions to provide the first depth information to the depth classification model; and
program instructions to reject, responsive to the depth classification model classifying the input as a 2D rendering, the 2D rendering as being the 3D subject.

8. The computer usable program product of claim 7, further comprising:
program instructions to present a 3D subject as an input to the multi-camera apparatus; collecting, using the multi-camera apparatus, a second depth information corresponding to the input;
program instructions to provide the second depth information to the depth classification model; and
program instructions to accept, responsive to the depth classification model classifying the input as a 3D subject, the 3D subject as being the 3D subject.

9. The computer usable program product of claim 7, further comprising:
program instructions to generate, from a scene presented as an input to the multi-camera apparatus, a depth map corresponding to the input, a greyscale value of a pixel in the depth map corresponding to a distance from the multi-camera apparatus to a portion of the scene.

10. The computer usable program product of claim 7, wherein configuring a depth classification model to distinguish between a 3D subject and a realistic 2D rendering of a 3D subject comprises training the depth classification model using a first set of depth information and a second set of depth information, the first set of depth information provided by viewing a set of 3D subjects via a multi-camera apparatus, the second set of depth information provided by viewing a set of realistic 2D renderings of the set of 3D subjects via a multi-camera apparatus.

11. The computer usable program product of claim 7, wherein the depth classification model comprises a convolutional neural network model.

12. The computer usable program product of claim 7, wherein the image classification model comprises a convolutional neural network model configured to classify a subject using a set of image classification training data, a training data in the set of image classification training data comprising an image and a classification corresponding to the image.

13. The computer usable program product of claim 7, wherein the computer usable code is stored in a computer readable storage device in a data processing system, and wherein the computer usable code is transferred over a network from a remote data processing system.

14. The computer usable program product of claim 7, wherein the computer usable code is stored in a computer readable storage device in a server data processing system, and wherein the computer usable code is downloaded over a network to a remote data processing system for use in a computer readable storage device associated with the remote data processing system.

15. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to present a 2D rendering of a 3D subject as an input to a multi-camera apparatus, the multi-camera apparatus operating an image classification model configured to classify a subject viewed via the multi-camera apparatus, and the multi-camera apparatus operating a depth classification model configured to distinguish between a depth characteristic of a 3D subject and a depth characteristic of a realistic 2D rendering of a 3D subject, using depth information provided by viewing a subject via the multi-camera apparatus;
program instructions to collect, using the multi-camera apparatus, a first depth information corresponding to the input;
program instructions to provide the first depth information to the depth classification model; and
program instructions to reject, responsive to the depth classification model classifying the input as a 2D rendering, the 2D rendering as being the 3D subject.

16. The computer system of claim 15, further comprising:
program instructions to present a 3D subject as an input to the multi-camera apparatus; collecting, using the multi-camera apparatus, a second depth information corresponding to the input;
program instructions to provide the second depth information to the depth classification model; and
program instructions to accept, responsive to the depth classification model classifying the input as a 3D subject, the 3D subject as being the 3D subject.

17. The computer system of claim 15, further comprising:
program instructions to generate, from a scene presented as an input to the multi-camera apparatus, a depth map corresponding to the input, a greyscale value of a pixel in the depth map corresponding to a distance from the multi-camera apparatus to a portion of the scene.

18. The computer system of claim 15, wherein configuring a depth classification model to distinguish between a 3D subject and a realistic 2D rendering of a 3D subject comprises training the depth classification model using a first set of depth information and a second set of depth information, the first set of depth information provided by viewing a set of 3D subjects via a multi-camera apparatus, the second set of depth information provided by viewing a set of realistic 2D renderings of the set of 3D subjects via a multi-camera apparatus.

19. The computer system of claim 15, wherein the depth classification model comprises a convolutional neural network model.

20. The computer system of claim 15, wherein the image classification model comprises a convolutional neural network model configured to classify a subject using a set of image classification training data, a training data in the set of image classification training data comprising an image and a classification corresponding to the image.
